(19) United States
(12) Patent Application Publication
(10) Pub. No.: US 2011/0151117 A1
(43) Pub. Date: Jun. 23, 2011

(54) Organic metal complexes for forming metal thin layer, ink including the same and method for forming metal thin layer using the same

(75) Inventors: Young Kwan Seo, Suwon (KR); Dong Hoon Kim, Seongnam (KR); Kwi Jong Lee, Suwon (KR)

(73) Assignee: SAMSUNG ELECTRO-MECHANICS CO., LTD., Suwon (KR)

(21) Appl. No.: 12/805,140

(22) Filed: Jul. 14, 2010

(30) Foreign Application Priority Data
Dec. 21, 2009 (KR) 10-2009-0128459

(51) Int. Cl. C09D 11/02; C07F 1/10; B05D 3/02

(52) U.S. Cl. 427/229; 556/117; 106/1.26

(57) ABSTRACT

There is provided organic metal complexes for forming a metal thin layer, ink including the same, and a method for forming a metal thin layer using the same: wherein the organic metal complexes for forming a metal thin layer include Ag, and a ligand represented by the specific general formula; the organic metal complexes have an excellent stability and solubility toward a solvent; and the ink for forming a metal thin layer comprising the organic metal complexes is easy to form a metal thin layer of, and could be applied on the substrate consisting of material having low thermal stability because the ink can be decomposed at a low temperature.

### CROSS-REFERENCE TO RELATED APPLICATIONS

This application claims the priority of Korean Patent Application No. 10-2009-0128459 filed on Dec. 21, 2009, in the Korean Intellectual Property Office, the disclosure of which is incorporated herein by reference.

### BACKGROUND OF THE INVENTION

1. Field of the Invention

The present invention relates to organic metal complexes for forming a metal thin layer, an ink including the same and a method for forming a metal thin layer using the same, and more particularly, to organic metal complexes for forming a metal thin layer, an ink including the same and a method for forming the metal thin layer using the same, in which the organic metal complexes have an excellent stability and solubility, and can be decomposed at a low temperature.

2. Description of the Related Art

In general, as more and more electronic equipment, data terminal equipment, and the like has recently become smaller and lighter, the sizes of electronic components, which may be used on the inside of equipment, have now also become compact. Therefore, a wiring pattern for mounting on the inside of electronic components has gradually become smaller, and also a width of a wiring pattern or the space between the wires thereof has gradually become narrower.

An example of an existing method for forming a metal pattern is a method including: forming a film on a silicon or a glass substrate using a metallic organic material by Chemical Vapor Deposition or Atomic Layer Deposition; applying a photosensitive resin to the film using Spin Coating; forming a pattern by photolithography; and removing the photosensitive resin by special etching.

Another method is a method including: forming a metal layer on a substrate using Plasma Deposition, Sputtering, Electro Deposition, and the like; applying a photosensitive resin to the metal layer; and forming a metal pattern by patterning using photolithography and etching.

Those existing methods require high temperature and high vacuum equipment, and should essentially accompany patterning using a photosensitive resin and etching for removing the photosensitive resin. The disadvantages of the methods are their high costs because the methods include many experimental processes. In addition, the methods require an additional planarization, because the surface of deposited material is not smooth.

Therefore, Inkjet Printing Technology, which can directly form a pattern on the substrate without mask deposition, has been developed to overcome the disadvantage of optical patterning.

Inkjet Printing Technology has been shown to have wide applicability because using the technology can selectively and quickly print on a range of fabricable materials (fabric, metal, ceramic, and polymer and the like) with a nano pattern. Various shapes can be freely printed on the various materials, such as fabric, metal, ceramic, polymer, and the like, as well as paper using Inkjet Printing Technology, because Inkjet Printing Technology can be described as spraying ink onto the desired place through a non-contact process. For this reason, the printing of a large area, such as a large-sized poster, a banner, and the like, having at least several square meters, can be made possible by using Inkjet Printing Technology.

The type of ink used in Inkjet Printing Technology is ink including metal nanoparticles, and the ink including metal nanoparticles includes a large quantity of a dispersing agent for the dispersion of metal nanoparticles. Therefore, usable substrates are limited, since a high temperature sintering process should be required for removing the dispersing agent. For this reason, a method for forming a metal thin layer using ink containing organic metal complexes has been recently suggested.

### SUMMARY OF THE INVENTION

An aspect of the present invention provides organic metal complexes for forming a metal thin layer, an ink including the same and a method for forming a metal thin layer using the same, in which the organic metal complexes have an excellent stability and solubility, and can be decomposed at a low temperature.

According to an aspect of the present invention, there are provided organic metal complexes for forming a metal thin layer including Ag; and a ligand represented by the following general formula (1):

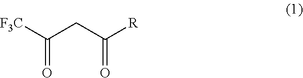

where: R is an alkyl or an aryl group with carbon number of 1 to 3.

The R in the organic metal complexes for forming the metal thin layer may be a phenyl group.

According to another aspect of the present invention, there is provided an ink for forming a metal thin layer including organic metal complexes including Ag and a ligand represented by the following general formula (1); and an organic solvent:

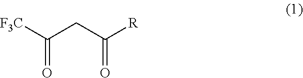

where: R is an alkyl or an aryl group with carbon number of 1 to 3.

The amount of the organic metal complexes may be 0.5 to 10 wt %.

The R in the organic metal complexes may be a phenyl group.

The organic solvent may be one or more selected from the group consisting of methanol, ethanol, isopropanol, butanol, ethylene glycol, glycerol, diethylene glycol, ethyl acetate, butyl acetate, propyl acetate, methyl ethyl ketone, acetone, benzene, and toluene.

According to another aspect of the present invention, there is provided a method for forming a metal thin layer including: preparing a substrate consisting of organic or inorganic material; forming a metal thin layer by applying ink for forming a metal thin layer on the substrate, in which the ink includes organic metal complexes including Ag and a ligand represented by the following general formula (1), and an organic solvent; and heat-treating the substrate:

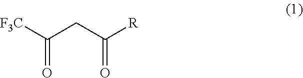

where: R is an alkyl or an aryl group with carbon number of 1 to 3.

The heat-treatment may be performed at less than 300° C.

In the method for forming a metal thin layer, the R in the organic metal complexes may be a phenyl group.

In addition, the organic solvent may be one or more selected from the group consisting of methanol, ethanol, isopropanol, butanol, ethylene glycol, glycerol, diethylene glycol, ethyl acetate, butyl acetate, propyl acetate, methyl ethyl ketone, acetone, benzene, and toluene.

### DETAILED DESCRIPTION OF THE PREFERRED EMBODIMENT

The present invention relates to organic metal complexes for forming a metal thin layer. Organic metal complexes for forming a metal thin layer according to an embodiment of the present invention include Ag; and a ligand represented by the following general formula (1):

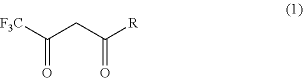

where: R is an alkyl or an aryl group with carbon number of 1 to 3.

More specifically, the R may be a methyl, an ethyl or a propyl, or an aryl group. The R may be a phenyl group.

The organic metal complexes for forming a metal thin layer according to the present invention may be synthesized by the reaction of a ligand represented by the above general formula (1) with a silver compound, such as a silver oxide, a silver nitrate, a silver chloride, etc. After synthesizing, the separated result is a white solid.

The organic metal complexes for forming a metal thin layer according to the present invention include Ag as a metal center, in which Ag has excellent electrical conductivity, excellent heat conductivity, and also high reflectance.

Derivatives of the compounds induced from Ag are limited and their disadvantages are as follows: lack of stability and solubility, or high decomposition temperature and slow decomposition as to the formation of a metal thin layer.

However, the organic metal complexes for forming a metal thin layer according to the present invention have an excellent stability and solubility toward a solvent. For this reason, the organic metal complexes for forming a metal thin layer according to the present invention are easy to form a metal thin layer of, and can be applied to a substrate consisting of material having low thermal stability because the complexes can be decomposed at low temperature.

The structure of the organic metal complexes for forming a metal thin layer according to the present invention may be represented by the following general formula (2):

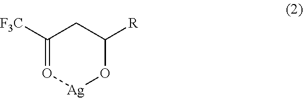

The organic metal complexes can be easily dissolved in various solvents, and can form a stable solution, which exhibits stability for storing.

The ink for forming a metal thin layer, which is obtained by dissolving the organic metal complexes in an organic solvent, can be used for printing. There are advantages that the ink has a low decomposition temperature and can be decomposed quickly.

Examples of the organic solvents, which can be used in the present invention, include, but are not particularly limited thereto, a type of alcohol, such as methanol, ethanol, isopropanol, butanol etc; a type of glycol, such as ethylene glycol, glycerol, diethylene glycol, etc; a type of acetate, such as ethyl acetate, butyl acetate, propyl acetate, etc; a ketone, such as methyl ethyl ketone, acetone, etc; aromatic-based organic solvents, such as benzene, toluene, etc; and one or more compounds of the above-mentioned organic solvents.

The amount of the organic metal complexes in the ink for forming a metal thin layer may be 0.5 to 10 wt %.

Another embodiment of the present invention also provides a method for forming a metal thin layer using ink for forming a metal thin layer.

As set forth above, the ink for forming a metal thin layer has advantages in that the decomposition temperature of the ink is low, and the decomposition of the ink is performed quickly. For this reason, the ink can be applied to the substrate consisting of material having low thermal stability to form a metal thin layer.

According to the embodiment of the present invention, a substrate consisting of organic or inorganic material is firstly prepared. The substrate may be consisted of a material such as bis maleic imide triazine, polyester, polyimide, glasses, silicone, and the like.

Since then, the ink for forming a metal thin layer is applied to the substrate consisting of organic or inorganic material to form a metal thin layer.

Forming a metal thin layer can be performed by various printing technologies, and the methods for forming a metal thin layer include, but are not limited thereto, for example, dip coating, spin coating, roll coating, spray coating, or inkjet printing.

Subsequently, heat-treatment is performed to form a metal thin layer. The heat-treatment may be performed at less than 300° C.

In addition, the heat treatment may be performed in the air, and may be performed in an atmosphere mixed with inert gases, such as nitrogen, argon, hydrogen, etc.

As described above, the ink for forming a metal thin layer according to the present invention can be applied to a substrate consisting of material having low thermal stability to form a metal thin layer, because the ink can be decomposed at low temperature.

### Example

The present invention will now be described in detail with reference to the Example. However, the following Example is only intended to describe the present invention in detail, and the spirit and scope of the invention will not be limited by the following Example.

### Preparation of Organic Metal Complexes

A Schlenk flask filled with nitrogen was covered with aluminum foil, and then was injected with 1.8 g (7.8 millimolars) of silver oxide. 40 milliliters of diethyl ether was added, and then stirred while the Schlenk flask was cooled at 0° C. using an ice bath. 3.5 g (16.2 millimolars) 4,4,4-trifluoro-1-phenyl-1,3-butadiene was then added slowly, and stirred for over 1 hour. The compound was then filtered to remove un-reacted silver oxide at room temperature, and the solvent was removed under vacuum to obtain 4.6 g (a yield of 88%) of silver complexes as a white solid.

### Example 1 through 6

The silver complexes obtained were combined with glycerol and diethylene glycol as per the following Table 1 using ethanol as a solvent to form ink. A substrate was printed using the ink by Inkjet Printing Technology, was thermally treated at 200° C. for 1 hour, and then the Surface Resistance of the substrate was measured.

### Comparative Example

Silver acetylacetonate, instead of the silver complexes obtained from the above-mentioned process, was combined with glycerol and diethyl glycol as per the following Table 1 using ethanol as a solvent to form ink. A substrate was printed using the ink by Inkjet Printing Technology, was thermally treated at 200° C. for 1 hour, and then the Surface Resistance of the substrate was measured.

TABLE 1

| | Organic metal | | Diethyl | Surface |
|---|---|---|---|---|
| | complexes | Glycerol | glycol | Resistance |
| | (wt %) | (wt %) | (wt %) | (mΩ/sq) |
| Example 1 | 2 | — | — | 200 |
| Example 2 | 2 | — | 5 | 250 |
| Example 3 | 5 | — | 15 | 350 |
| Example 4 | 5 | 10 | 5 | 400 |
| Example 5 | 10 | 10 | 15 | 450 |
| Example 6 | 10 | 20 | 5 | 520 |
| Com. Example | 5 | 20 | 15 | 3000 |

As set forth above, according to exemplary embodiments of the invention, the organic metal complexes for forming a metal thin layer according to the present invention have an excellent stability and solubility toward a solvent.

Therefore, the organic metal complexes according to the present invention are dissolved in an organic solvent, and the ink obtained for forming a metal thin layer can be used for printing.

The ink for forming a metal thin layer according to the present invention is easy to form a metal thin layer of, and can be applied to a substrate consisting of material having low thermal stability because the ink can be decomposed at low temperature.

While the present invention has been shown and described in connection with the exemplary embodiments, it will be apparent to those skilled in the art that modifications and variations can be made without departing from the spirit and scope of the invention as defined by the appended claims.

What is claimed is:

1. Organic metal complexes for forming a metal thin layer, comprising:
Ag; and
a ligand represented by the following general formula (1); 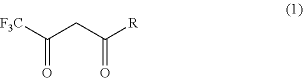
where: R is an alkyl or an aryl group with carbon number of 1 to 3.

2. The organic metal complexes of claim 1, wherein the R is a phenyl group.

3. Ink for forming a metal thin layer, comprising:
organic metal complexes comprising Ag, and a ligand represented by the following general formula (1); and
an organic solvent; 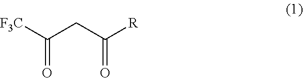
where: R is an alkyl or an aryl group with carbon number of 1 to 3.

4. The ink of claim 3, wherein the amount of the organic metal complexes is 0.5 to 10 wt %.

5. The ink of claim 3, wherein the R is a phenyl group.

6. The ink of claim 3, wherein the organic solvent is one or more selected from the group consisting of methanol, ethanol, isopropanol, butanol, ethylene glycol, glycerol, diethylene glycol, ethyl acetate, butyl acetate, propyl acetate, methyl ethyl ketone, acetone, benzene, and toluene.

7. A method for forming a metal thin layer, comprising:
preparing a substrate consisting of organic or inorganic material;
forming a metal thin layer by applying the ink to the substrate, in which the ink includes organic metal complexes comprising Ag and a ligand represented by the following general formula (1), and an organic solvent; and
Heat-treating the substrate: 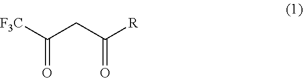
where: R is an alkyl or an aryl group with carbon number of 1 to 3.

8. The method of claim 7, wherein the heat-treatment is performed at less than 300° C.

9. The method of claim 7, wherein the R is a phenyl group.

10. The method of claim 7, wherein the organic solvent is one or more selected from the group consisting of methanol, ethanol, isopropanol, butanol, ethylene glycol, glycerol, diethylene glycol, ethyl acetate, butyl acetate, propyl acetate, methyl ethyl ketone, acetone, benzene, and toluene.
